(19) United States
(12) Patent Application Publication
(10) Pub. No.: US 2026/0267094 A1
(43) Pub. Date: Sep. 10, 2026

(54) METHODS AND APPARATUS EMPLOYING DETACHABLE FIBEROPTIC CONNECTOR WITH SELF-ALIGNING FEATURES

(71) Applicant: Ciena Corporation, Hanover, MD (US)

(72) Inventors: Weizhuo Li, Berkeley Heights, NJ (US); Clinton Randy Giles, Watching, NJ (US); Siamak Abbaslou, Jersey City, NJ (US); Peter Winzer, Aberdeen, NJ (US); Fred W. Warning, Mertztown, PA (US)

(21) Appl. No.: 19/557,745

(22) Filed: Mar. 5, 2026

Related U.S. Application Data
(60) Provisional application No. 63/767,962, filed on Mar. 6, 2025.

(51) Int. Cl. G02B 6/42; G02B 6/43

(52) U.S. Cl. CPC G02B 6/4243; G02B 6/4231; G02B 6/4249; G02B 6/43

(57) ABSTRACT

An example fiberoptic connector has a plug portion including a FALA connected to optical fibers and a socket portion including a PCLA optically coupled to a PIC. The connector also includes a coarse alignment feature having complementary components in the plug and socket portions and a fine alignment feature including a sphere attached to one of the FALA and PCLA and further including a groove in another one of the FALA and PCLA. The components operate to bring the sphere into a capture range of the groove when the plug portion is inserted into the socket portion. When within the capture range, the groove operates to guide the sphere into a stable position within the groove to achieve an optically aligned state for the FALA and the PCLA in which the optical fibers are optically coupled to corresponding vertical grating couplers in the PIC.

### CROSS-REFERENCE TO RELATED APPLICATIONS

This application claims the benefit of U.S. Provisional Patent Application No. 63/767,962, filed 6 Mar. 2025, and entitled “METHODS AND APPARATUS EMPLOYING DETACHABLE FIBEROPTIC CONNECTOR WITH SELF-ALIGNING FEATURES,” the

contents of which are incorporated herein by reference.

### FIELD OF THE DISCLOSURE

Various example embodiments relate to optical communication equipment and, more specifically but not exclusively, to fiberoptic connectors.

### BACKGROUND

Fiberoptic connectors, also sometimes referred to as terminations, are used to connect fiberoptic cables to each other or to optical and/or optoelectronic devices. To accommodate different applications, there are many fiberoptic connector types. Having the correct connector type and design for a specific use case may typically ensure nearly optimal performance of the corresponding fiberoptic cables and the devices they connect.

### BRIEF SUMMARY OF SOME SPECIFIC EMBODIMENTS

An example detachable fiberoptic connector includes coarse and fine alignment features. In some examples, a coarse alignment feature includes pins and pin guides located on the plug and socket portions of the connector, respectively. A fine alignment feature may include one or more microspheres, with each microsphere being registered with two V-grooves or other concave structures facing each other on the two detachably mating surfaces of the connector. The pins and pin guides operate to bring the microspheres into a capture range of the V-grooves when the plug portion is inserted into the socket portion. When within the capture range, the V-grooves operate to guide the microspheres into respective stable positions therein to achieve a nearly optimal optical alignment between the plug and socket portions of the fiberoptic connector.

In one example, a fiberoptic connector comprises: a plug portion including a first lens array element connected to a plurality of optical fibers; a socket portion including a second lens array optically coupled to a photonic chiplet; a first alignment feature including a first sphere fixedly attached to one of the plug portion and the socket portion and further including a first groove in another one of the plug portion and the socket portion, wherein the first groove is configured to guide the first sphere into a stable position within the first groove to achieve an optically aligned state for the first and second lens arrays in which the plurality of optical fibers is optically coupled to a corresponding plurality of photonic components in the photonic chiplet.

In another example, a fiberoptic connector comprises: a plug portion including a fiber array lens array (FALA) connected to a plurality of optical fibers; a socket portion including a photonic coupler lens array (PCLA) optically coupled to surface grating couplers of a photonic chiplet; a coarse alignment feature having a first component in the plug portion and a second component in the socket portion; and a fine alignment feature including a first sphere fixedly attached to one of the FALA and the PCLA and further including a first groove in another one of the FALA and the PCLA, wherein the first and second components are configured to bring the first sphere into a capture range of the first groove when the plug portion is inserted into the socket portion; and wherein, when within the capture range, the first groove is configured to guide the first sphere into a stable and accurate position within the first groove to achieve an optically aligned state for the FALA and the PCLA in which the plurality of optical fibers is optically coupled to a corresponding plurality of grating couplers in the photonic chiplet.

In yet another example, a method for manufacturing a fiberoptic connector comprises: assembling a plug portion of the fiberoptic connector, wherein the assembling includes connecting a first lens array to a plurality of optical fibers; making a socket portion of the fiberoptic connector, wherein the making includes attaching a second lens array to a photonic chiplet such that a plurality of lenses of the second lens array is optically coupled to a corresponding plurality of photonic components in the photonic chiplet; and gluing a first sphere to one of the first and second lens arrays, wherein another one of the first and second lens arrays has a first groove configured to register with the first sphere, wherein the first groove is configured to guide the first sphere into a stable position within the first groove to achieve an optically aligned state for the first and second lens arrays in which the plurality of optical fibers is optically coupled to the corresponding plurality of photonic components.

In yet another example, a method for manufacturing a fiberoptic connector comprises: assembling a plug portion of the fiberoptic connector, the plug portion comprising a first component of a coarse alignment feature of the fiberoptic connector, wherein the assembling includes connecting a FALA to a plurality of optical fibers; making a socket portion of the fiberoptic connector, the socket portion comprising a second component of the coarse alignment feature of the fiberoptic connector, wherein the making includes attaching a PCLA to a photonic chiplet such that a plurality of lenses of the PCLA is optically coupled to a corresponding plurality of grating couplers in the photonic chiplet; and gluing a first sphere to one of the FALA and the PCLA, wherein another one of the FALA and the PCLA has a first groove configured to register with the first sphere, wherein the first and second components are configured to bring the first sphere into a capture range of the first groove when the plug portion is inserted into the socket portion; and wherein, when within the capture range, the first groove is configured to guide the first sphere into a stable and accurate position within the first groove to achieve an optically aligned state for the FALA and the PCLA in which the plurality of optical fibers is optically coupled to the corresponding plurality of grating couplers.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 schematically shows a perspective view of an integrated-circuit (IC) assembly according to some examples.

FIG. 2 is a schematic diagram illustrating a cross-sectional side view of a detachable fiberoptic connector used in the integrated-circuit assembly of FIG. 1 according to some examples.

FIG. 3 schematically illustrates a capture of a microsphere in a respective V-shaped groove of the detachable fiberoptic connector of FIG. 2 according to some examples.

FIGS. 4A-4B schematically illustrate symmetric and asymmetric mating, respectively, implemented in the detachable fiberoptic connector of FIG. 2 according to some examples.

FIG. 5 is a schematic diagram illustrating a cross-sectional side view of a groove lithographically etched in silicon and used to implement a fine-alignment feature in the detachable fiberoptic connector of FIG. 2 according to some examples.

FIG. 6 is a schematic diagram illustrating a plan view of a grating coupler lens array used in the detachable fiberoptic connector of FIG. 2 according to some examples.

FIGS. 7A-7C pictorially illustrate a cable escape scenario implemented with the detachable fiberoptic connector of FIG. 2 according to some examples.

FIGS. 8A-8C pictorially illustrate another cable escape scenario implemented with the detachable fiberoptic connector of FIG. 2 according to some additional examples.

FIGS. 9A-9F pictorially illustrate a process flow for assembling the detachable fiberoptic connector of FIG. 2 according to some examples.

FIG. 10 is a schematic diagram illustrating an alternative groove shape used in the detachable fiberoptic connector of FIG. 2 according to some examples.

FIG. 11 is a schematic diagram illustrating an alternative geometric shape for the coarse alignment feature used in the detachable fiberoptic connector of FIG. 2 according to some examples.

FIGS. 12A-12C schematically illustrate a detachable fiberoptic connector including a holding mechanism according to some examples.

FIGS. 13A-13B schematically illustrate a detachable fiberoptic connector with a holding mechanism according to some additional examples.

### DETAILED DESCRIPTION

Some embodiments disclosed herein may benefit from certain features disclosed in U.S. Pat. Nos. 11,287,585, 12,029,004, 11,988,874, 11,982,848, and 12,461,321 and U.S. Patent Application Publication No. 2024/0097796, each of which is incorporated herein by reference in its entirety.

In CPO (co-packaged optics) or NPO (near packaged optics), electrical and photonics integrated circuits (ICs) may be attached with Ball Grid Array (BGA) or similar high-density electrical connection methods to a printed circuit board (PCB) or a substrate, which typically involves the assembly to undergo solder reflow at relatively high temperature. Conventional attachment of fiber optic cables, where the fibers are glued to the photonic IC (PIC), may not be compatible with at least some implementations of this solder reflow process. Furthermore, in some examples, when one of the connected fibers is damaged, the whole structure may become functionally deficient and may have to be scrapped. A detachable fiber optic connector can be used to beneficially address the above-indicated challenges and provide a viable solution for at least some applications.

In some examples, two types of fiber-to-chip optical couplings may be used: (i) vertical coupling and (ii) edge coupling. Vertical coupling provides for out-of-plane coupling of light onto the corresponding PIC, while edge coupling couples light through the cleaved or polished edge of the PIC. For either vertical coupling or edge coupling, two approaches may be used: (a) direct butt coupling or (b) expanded beam coupling. Expanded beam coupling is typically implemented with more components than direct butt coupling and is used to relax alignment tolerances and reduce sensitivity to particulate contamination, particularly for detachable connections.

Example embodiments disclosed herein may include one or more alignment features, e.g., for use in detachable fiberoptic connectors. In some examples, such alignment features may include one or more microspheres with each microsphere registered with two V-grooves or other concave structures facing each other on the two detachably mating surfaces. In an embodiment of expanded beam coupling for either edge coupling or vertical coupling, such V-grooves may be fabricated on the components containing the two lens arrays that form the expanded-beam connection. In an embodiment of direct butt coupling for either edge coupling or vertical coupling, the V-groove features may be fabricated on the PIC and on the fiber attach unit (FAU).

In various examples, the specific number of microspheres to be used depends on the application. Generally, two microspheres may be used for a 1D lens array, and three or more microspheres may be used for a 2D lens array. In some examples, more than two or more than four microspheres may be used to improve alignment capture during the mating process. With the disclosed alignment features, the relative position of two lens arrays precisely registers repeatably every time the connector is mated.

One example embodiment uses expanded beam coupling for vertical grating coupling to PICs. Therein, two lens arrays may be used. The first array is referred to as the Grating Coupler Lens Array (GCLA), aligned to the on-PIC vertical grating couplers and attached to the PIC. The other array is referred to as the Fiber Array Lens Array (FALA), which may be actively or passively aligned with and glued to a FAU, an element that holds in alignment a 1D or 2D array of fibers. In some examples, the GCLA may be actively or passively aligned with and glued to the PIC, e.g., using a “golden” fiber connector unit (FCU) for active alignment. An FCU is an FAU with a FALA glued to it. An FCU may also have a connector unit with coarse alignment features attached to the FALA and/or FAU. A golden FCU is an FCU that is made with high geometrical and optical accuracy to be used as a standard for aligning and building assemblies. After placing and attaching the GCLA to the PIC, a socket frame may be placed around the GCLA. The socket frame may be made, e.g., from molded plastic, and may be attached to the PIC, to the GCLA, or to any other suitable structure within reasonable tolerance to the GCLA, such as a module base. In some embodiments, the socket frame is made of several discrete pieces. The socket frame contains features (e.g., holes, grooves, bevels, etc.) to coarsely (e.g., to within 10, 20, 40, 80, or 160 micron) align an FCU to the GCLA using the corresponding counter-features (e.g., pins, protrusions, etc.). These features align the FCU to within the capture range of the microsphere/V-groove mechanism such that the FALA is fine-aligned (e.g., to within 1, 2, 4, or 8 μm) to the GCLA using the microspheres described herein. In some additional examples, protruding features fabricated in the corresponding components to fit into the grooves may be used instead of or in addition to discrete microsphere components. The socket frame may be actively or passively aligned and glued to the PIC, e.g., actively aligned using a golden FCU. The light beams between the two lens arrays are collimated, whereas the light beams on either side of the two-lens assembly are focused to achieve nearly minimum optical losses between the optical fibers and the matching grating couplers or waveguides. The two lens arrays can be configured to allow beams to pass through the assembly as straight beams or as angled beams. Angled FCUs, with beams typically angled by 6-8 degrees, may be used to reduce back reflections that may degrade the optical system performance.

In some examples, a GCLA can be replaced by a photonic coupler lens array (PCLA). In such cases, the corresponding PIC may comprise vertical coupling or photonic elements including turning mirrors or other functionally suitable optical elements. In some examples, the PCLA may be coupled to photodiodes or VCSELs in the PIC. In some examples, the coupling and/or photonic elements include one or more elements selected from the group consisting of a grating coupler, a turning mirror, a photodetector, and a laser.

In some examples, the microspheres may be permanently attached to the V-groove pit on the GCLA or to those on the FALA. Fine passive alignment resulting in low optical coupling losses may be achieved when attaching the FCU comprising a FALA and a FAU to the GCLA/PIC, and the microspheres will engage with the matching V-grooves on the other lens array. The connection is “removable,” e.g., is capable of being coupled and uncoupled repeatedly and non-destructively. In addition to the fine passive alignment with the microspheres, the preceding coarse alignment may be achieved by pin-hole engagement on frames surrounding the lens arrays.

In some examples, for 2D lens arrays, the FAU optical fibers can be escaped from any side or orientation. The locations of both coarse-alignment features and fine-alignment features may be chosen to be nearly optimal for the specifications of the PIC and other components surrounding the FAU connector area. In some embodiments, those locations are chosen along the side of the array that defines the escape direction of the fibers. These choices may be directed to maximizing the beachfront size.

In some examples, compared with some other shapes, V-grooves may lead to better piece part tolerances.

In some examples, for lens arrays made with a silicon material, V-grooves may be fabricated by wet etching of crystalline (100) silicon, which can be made with sub-micron accuracy at a relatively low cost due to the availability of established (e.g., CMOS) semiconductor manufacturing processes for these purposes. Microspheres may be seated inside the silicon V-groove. X/Y/Z positions of the microspheres are typically accurately defined by the (111) side walls of the silicon V-groove. In addition, the (111) planes (where the microspheres are seated) may be considered to have a relatively high-quality surface, e.g., due to better smoothness and lower defect density compared to some other silicon planes.

In some examples, for lens arrays made with other materials, the shape of the V-grooves may be defined by means of producing them and will be located with and have features of micron or sub-micron accuracy.

In some examples, lens arrays may be made of silicon, fused silica, or other suitable materials. Microspheres may be made of fused silica, cubic zirconia, or other materials and may be made in different sizes. For some applications, microspheres may provide the advantages of low cost and the possibility of wafer level attachment. Generous tolerances for microsphere placement due to the V-groove self-alignment capability beneficially allows for more flexibility in manufacturing or assembly.

In some embodiments, additional grooves may be etched or cut into the material next to the V-grooves to prevent the adhesive (which holds the microspheres in place within the V-grooves) from spilling into the optically active zone containing lenses, fibers, and/or couplers.

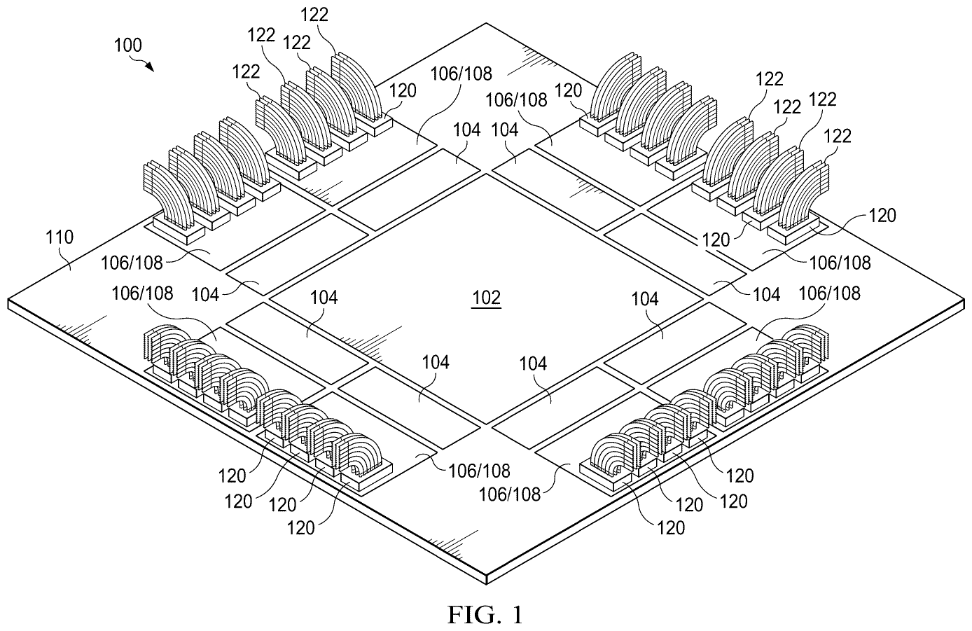

FIG. 1 schematically shows a perspective view of an IC assembly 100 according to some examples. In the example shown, the IC assembly 100 includes a data processing chiplet 102, a plurality of converter chiplets 104, a plurality of electronic amplification chiplets (EACs) 106, and a plurality of photonic chiplets 108 that are directly or indirectly mounted on a common substrate (e.g., a PCB) 110. The EACs 106 and the photonic chiplets 108 are arranged in pairs, with each pair including one photonic chiplet 108 stacked on top of one EAC 106, e.g., using a flip-chip arrangement. A respective plurality of fiberoptic connectors 120 is attached to or mounted on the upper side of the respective photonic chiplet 108. A respective plurality of optical fibers or waveguides 122 (e.g., arranged as a 2D array) is connected and optically coupled to each fiberoptic connector 120.

In various examples, the data processing chiplet 102 may be or include a network switch, a central processing unit (CPU), a graphics processor unit (GPU), a tensor processing unit (TPU), a digital signal processor (DSP), an application specific integrated circuit (ASIC), and/or a storage device (e.g., a solid-state memory device).

Herein, the term “photonic chiplet” refers to a chiplet that includes a “photonic module” or a “photonic integrated circuit (PIC).” The terms “photonic module” and “photonic integrated circuit” may be used interchangeably. The term “photonic integrated circuit” should be construed to cover planar lightwave circuits (PLCs), integrated optoelectronic devices, wafer-scale products on substrates, individual photonic chips and dies, and hybrid devices. Example material systems that can be used for manufacturing various PICs may include but are not limited to III-V semiconductor materials, silicon photonics, silica-on-silicon products, silica-glass-based PLCs, polymer integration platforms, lithium niobate and derivatives, nonlinear optical materials, etc. Both packaged devices (e.g., wired-up and/or encapsulated chips) and unpackaged devices (e.g., dies) can be referred to as PICs.

In some examples, a chiplet may be a semiconductor die or a die stack. A die is a small block of semiconducting material on which an electrical and/or optical integrated circuit is fabricated. Several integrated circuits are produced on a wafer of silicon or other semiconductor (such as GaAs) through fabrication processes, such as photolithography. The wafer is cut or diced into many pieces, each containing one or more of the integrated circuits. Each of these pieces may be referred to as a die. When two or more dies are stacked together vertically, the combination of the two or more dies is referred to as a die stack.

PICs may be used for various applications in telecommunications, instrumentation, and signal-processing fields. A PIC typically uses optical waveguides to implement and/or interconnect various circuit components, such as optical switches, couplers, routers, splitters, multiplexers/demultiplexers, filters, modulators, phase shifters, lasers, amplifiers, wavelength converters, optical-to-electrical (O/E) and electrical-to-optical (E/O) signal converters, etc. A waveguide in a PIC is usually an on-chip solid light conductor that guides light due to an index-of-refraction contrast between the waveguide's core and cladding. A PIC typically comprises a planar substrate onto which optoelectronic devices are grown by additive manufacturing processes and/or into which optoelectronic devices are etched by subtractive manufacturing processes, e.g., using a multi-step sequence of photolithographic and chemical processing steps.

An “optoelectronic device” can operate on both light and electrical currents (voltages) and may include one or more of: (i) an electrically driven light source, such as a laser diode; (ii) an optical amplifier; (iii) an optical-to-electrical converter, such as a photodiode; and (iv) an optoelectronic component that can control the propagation and/or certain properties of light, such as an optical modulator or a switch. The corresponding optoelectronic circuit may additionally include one or more optical elements and/or one or more electronic components that enable the use of the circuit's optoelectronic devices in a manner consistent with the circuit's intended function. Some optoelectronic devices can be implemented using one or more PICs.

As used herein, the term “integrated circuit” (IC) should be construed to encompass both a non-packaged die and a packaged die. In a typical IC-fabrication process, dies (chips) are produced in relatively large batches using wafers of silicon or other suitable material(s). Electrical and optical circuits can be gradually created on a wafer using a multi-step sequence of photolithographic and chemical processing steps. Each wafer is then cut (“diced”) into many pieces (chips, dies), each containing a respective copy of the circuit that is being fabricated. Each individual die can be appropriately packaged prior to being incorporated into a larger circuit or be left non-packaged.

The term “hybrid circuit” can refer to a multi-component circuit constructed of multiple monolithic ICs and possibly some discrete circuit components, all attached to each other to be mountable on and electrically connectable to a common base or carrier. A representative hybrid circuit may include (i) one or more packaged or non-packaged dies, with some or all of the dies including optical, optoelectronic, and/or semiconductor devices, and (ii) one or more optional discrete components, such as connectors, resistors, capacitors, and inductors. Electrical connections between the ICs, dies, and discrete components can be formed, e.g., using patterned conducting (such as metal) layers, ball-grid arrays, solder bumps, wire bonds, etc. Individual ICs may include any combination of one or more respective substrates, one or more redistribution layers (RDLs), one or more interposers, one or more laminate plates, etc.

In some examples, individual chips can be stacked. As used herein, the term “stack” refers to an orderly arrangement of packaged or non-packaged dies in which the main planes of the stacked dies are substantially parallel to each other. A stack can typically be mounted on a carrier in an orientation in which the main plains of the stacked dies are parallel to each other and/or to the main plane of the carrier.

A “main plane” of an object, such as a die, a PIC, a substrate, or an IC, is a plane parallel to a substantially planar surface thereof that has the largest sizes, e.g., length and width, among all exterior surfaces of the object. This substantially planar surface can be referred to as a main surface. The exterior surfaces of the object that have one relatively large size, e.g., length, and one relatively small size, e.g., height, are typically referred to as the edges of the object.

In some examples, the photonic chiplet 108 can be based on any suitable PIC technology/material platform, such as, without any implied limitation, silicon photonics, indium phosphide, or lithium niobate. The photonic chiplet 108 includes, supported on a substrate, suitably connected passive optical elements and/or arrays of passive optical elements, such as optical waveguides, couplers, splitters, filters, delay lines, etc., and optoelectronic elements and/or arrays of optoelectronic elements, such as modulators, detectors, and tunable phase shifters. Some of these elements can be vertical-coupling elements configured to couple light to/from the PIC. Herein, the “vertical” direction is a direction that is perpendicular to a main surface of the PIC. In the context of this specification, the term “vertical-coupling” denotes coupling at an angle that is substantially out-of-plane relative to a main surface of the substrate of the PIC, but not necessarily perpendicular to the main surface. In some examples, vertical coupling can be implemented at angles between 0 degrees (perpendicular) and, e.g., 45 degrees as measured from the surface-normal of the substrate's main surface. The coupling can be performed from the top side (e.g., the waveguide-side) of the PIC or from the bottom-side (e.g., the substrate-side) of the PIC. In some examples where top-side coupling or bottom-side coupling is used, the light beams can be directed toward or from the top side or bottom side of the PIC at an angle greater than, e.g., 45 degrees as measured from the surface-normal of the substrate's main surface.

In some examples, the data processing chiplet 102 transmits or receives a slow-and-parallel data stream to or from the converter chiplet 104. The converter chiplet 104 transmits or receives a fast-and-serial data stream to or from the electronic amplification chiplet 106. The slow-and-parallel data stream can have a first set of a first number of bit streams, each bit stream at a first bit rate. The fast-and-serial data stream can have a second set of a second number of bit streams, each bit stream at a second bit rate. In some examples, the converter chiplet 104 adds coding overhead to the first set of the first number of bit streams in the process of converting the first set of the first number of bit streams to the second set of the second number of bit streams. In some examples, the product of the first number of bit streams and the first bit rate is approximately equal to the product of the second number of bit streams and the second bit rate. In some examples, the product of the first number of bit streams and the first bit rate is in a range from 66% to 150% of the product of the second number of bit streams and the second bit rate.

In the example shown, the interconnection between the data processing chiplet 102 and the converter chiplet 104 complies with the bunch of wire (BoW) (or similar wide, parallel input/output standard chiplet interface) channel/equalization specification. The pitch density can be, e.g., up to 500 lines/mm, and the data rate can be, e.g., 16 Gbps per lane. The interconnection between the converter chiplet 104 and the electronic amplification chiplet 106 complies with the XSR+ channel/equalization specification. The data rate can be, e.g., 112 Gbps per lane. The pitch density in the silicon interposer or in a substrate made using the Fan-Out Wafer-Level Packaging (FOWLP) fabrication process can also have other values, subject to signal integrity electrical constraints to support the specified data rate.

The converter chiplet 104 performs signal format conversion between the electrical signals from/to the data processing chiplet 102 and the electrical signals to/from the electronic amplification chiplet 106. For example, for the signal paths from the data processing chiplet 102 to the electronic amplification chiplet 106, serializers (which may include multiplexers) are used to serialize the parallel signals. For the signal paths from the electronic amplification chiplet 106 to the data processing chiplet 102, de-serializers (which may include de-multiplexers) are used to parallelize the serial signals. In some examples, the signal paths from the data processing chiplet 102 to the electronic amplification chiplet 106 include dedicated lanes for forwarding a clock signal. In some examples, the signals from the electronic amplification chiplet 106 to the data processing chiplet 102 include embedded information used to forward a clock signal.

In reference to an integrated circuit, such as the data processing chiplet 102 or PIC 108, the term “beachfront” (or alternatively “shoreline”) refers to the perimeter or edge of the die (or chiplet) where high-speed Input/Output (I/O) connections are located. The term “beachfront direction” typically refers to the orientation and layout of these interconnects along the die's edge configured to facilitate communication with other components, such as other chiplets, within the same IC assembly, such as the IC assembly 100.

Important characteristics of the beachfront in the IC package or assembly may include:
Edge-Based Connectivity: Beachfront density is an important metric, measuring the amount of bandwidth (e.g., Gigabits per second) that can be transmitted per millimeter of the die's edge.
Interoperability: Standardized interfaces like Universal Chiplet Interconnect Express (UCIe) use a fixed beachfront value to ensure that chiplets from different vendors can be physically and electrically compatible.
Bandwidth Maximization: Engineers design the beachfront to maximize I/O density. For example, the use of certain new technologies can double the beachfront bandwidth for memory traffic by utilizing bidirectional transceivers.
Advanced Packaging Applications: Beachfront is particularly important in 2.5D and 3D packaging, where short, high-density traces connect dies along their adjacent edges to reduce latency and power consumption.

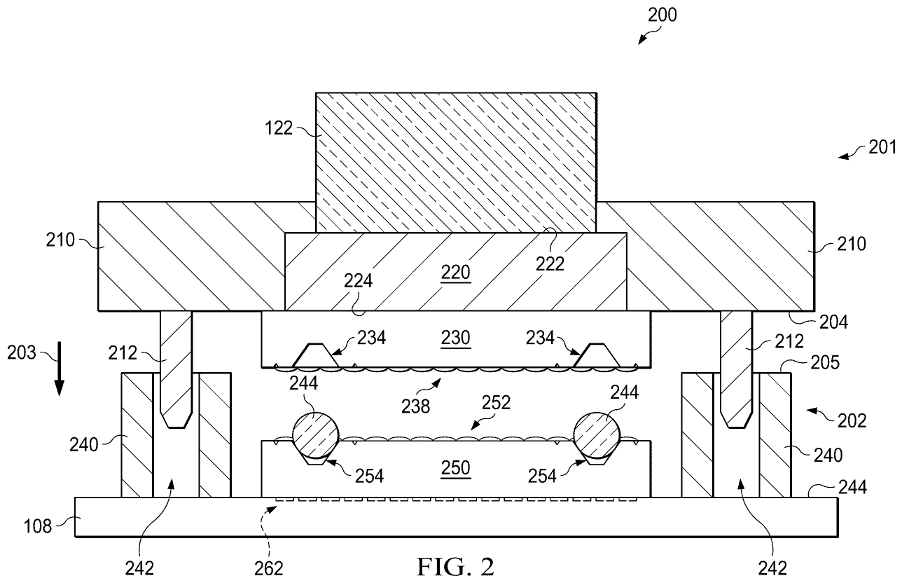

FIG. 2 is a schematic diagram illustrating a cross-sectional side view of a detachable fiberoptic connector 200 used in the IC assembly 100 according to some examples. More specifically, the connector 200 is an implementation of the fiberoptic connector 120 (FIG. 1). The connector 200 comprises a plug portion 201 and a socket portion 202. The socket portion 202 may also be referred to as the receptacle portion. In the relative position of the two portions illustrated in FIG. 2, the plug portion 201 and the socket portion 202 are in a partially engaged state, in which a coarse alignment feature 212/240 of the connector 200 is engaged whereas a fine alignment feature 234/244/254 of the connector 200 is disengaged.

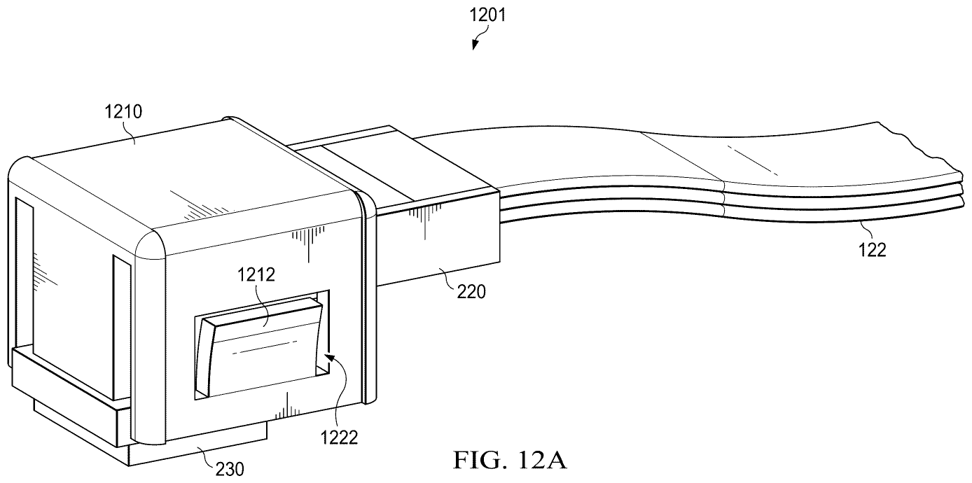

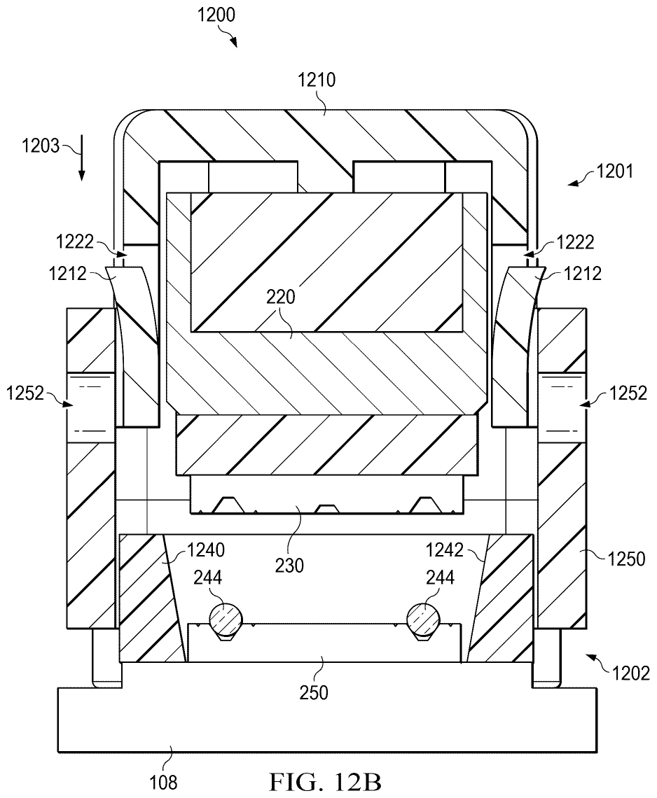

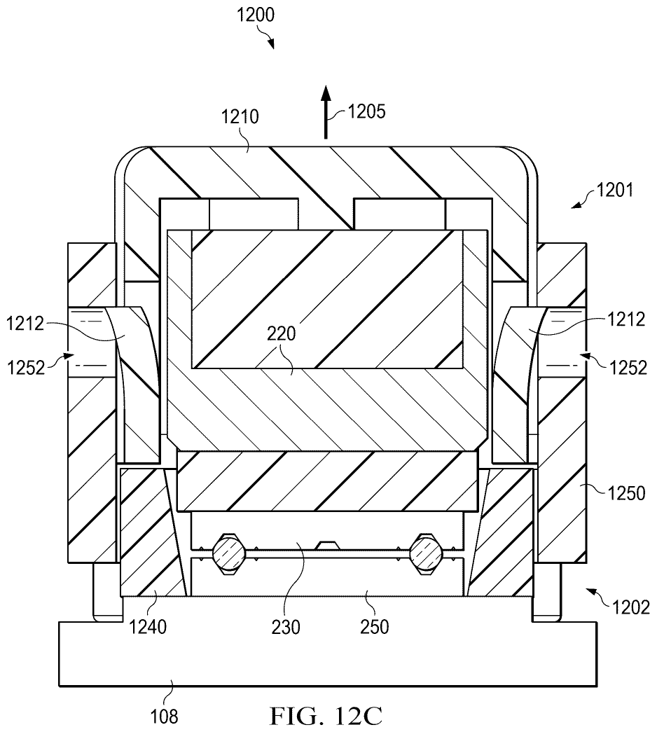

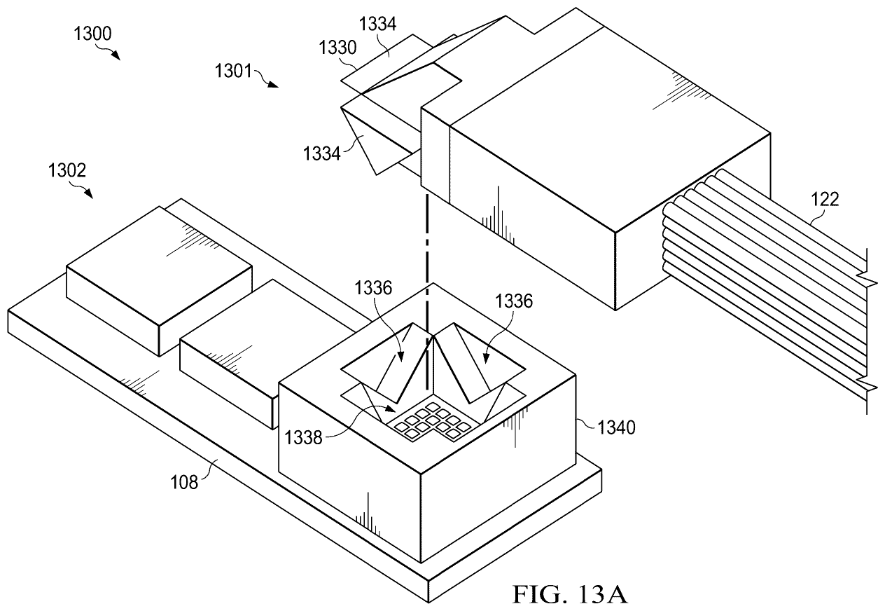

To engage the fine alignment feature 234/244/254 of the connector 200, the plug portion 201 can be pushed towards the socket portion 202 along a direction 203. In some examples, the connector 200 may include a holding mechanism (not explicitly shown in FIG. 2; e.g., see FIG. 12) configured to fix and hold the plug portion 201 and the socket portion 202 together in this position. The holding mechanism can be released to separate the plug portion 201 and the socket portion 202 from one another when needed. In some examples, the holding mechanism includes a molded plastic shell with a tabs latch, a sheet-metal release cover, and a spring positioned between the cover and a frame 210. In the example shown, the direction 203 is substantially orthogonal to a main surface of the photonic chiplet (PIC) 108.

The plug portion 201 of the connector 200 includes the frame 210 with pins 212 protruding from the frame surface 204 toward the socket portion 202. In the example shown, the plug portion 201 has two pins 212. In other examples, a different (from two) number of pins 212 can also be used. Attached to the frame 210 is a fiber attach unit (FAU) 220. A bundle of fibers 122 is attached at a first side 222 of the FAU 220. A fiber array lens array (FALA) 230 is attached at an opposite second side 224 of the FAU 220.

The socket portion 202 includes pin guides 240 fixedly attached to a surface 244 of the photonic chiplet 108 facing the plug portion 201. Each of the pin guides 240 has a respective cylindrical opening (hole) 242 configured to receive the corresponding pin 212, e.g., as indicated in FIG. 2. The hole 242 has a larger diameter than the pin 212 to enable relatively easy pin insertion and capture for the coarse alignment of the connector 200 and further enable lateral adjustment of the pin position during the fine alignment of the connector 200. The pins 212 and the pin guides 240 form the above-mentioned coarse alignment feature 212/240 of the connector 200.

Also attached to the surface 244 of the photonic chiplet 108 is a grating coupler lens array (GCLA) 250. The attachment is such that a lens array 252 of the GCLA 250 is aligned with and optically coupled (with a relatively low, e.g., nearly minimum, insertion loss) to an array of on-PIC vertical grating couplers 262 of the photonic chiplet 108. When engaged, the fine alignment feature 234/244/254 of the connector 200 causes the lens array 252 of the GCLA 250 to be aligned with and optically coupled (with a relatively low, e.g., nearly minimum, insertion loss) to a lens array 238 of the FALA 230.

The fine alignment feature 234/244/254 of the connector 200 comprises V-shaped grooves 234 on the FALA 230, V-shaped grooves 254 on the GCLA 250, and microspheres 244 for engaging the facing pairs of the grooves 234 and 254. In the example shown, each microsphere 244 is fixedly attached (e.g., glued) to the respective V-shaped groove 254 in a respective groove-centered position. When the plug portion 201 is pushed towards the socket portion 202 along the direction 203, the microspheres 244 engage the facing V-shaped grooves 234 on the FALA 230 and cause lateral movement of the FALA 230 which results in the lens array 238 being aligned with the lens array 252 of the GCLA 250 when the microspheres 244 come to rest within the V-shaped grooves 234.

In some other examples, each microsphere 244 may be fixedly attached (e.g., glued) to the respective V-shaped groove 234 in a respective groove-centered position. In further examples, some of the microspheres 244 are fixedly attached to the respective V-shaped grooves 234 while the rest of the microspheres 244 are fixedly attached to the corresponding V-shaped grooves 254. In additional examples, the microspheres 244 may not be glued to the grooves, but instead be held in place in the lower grooves, by the force of gravity.

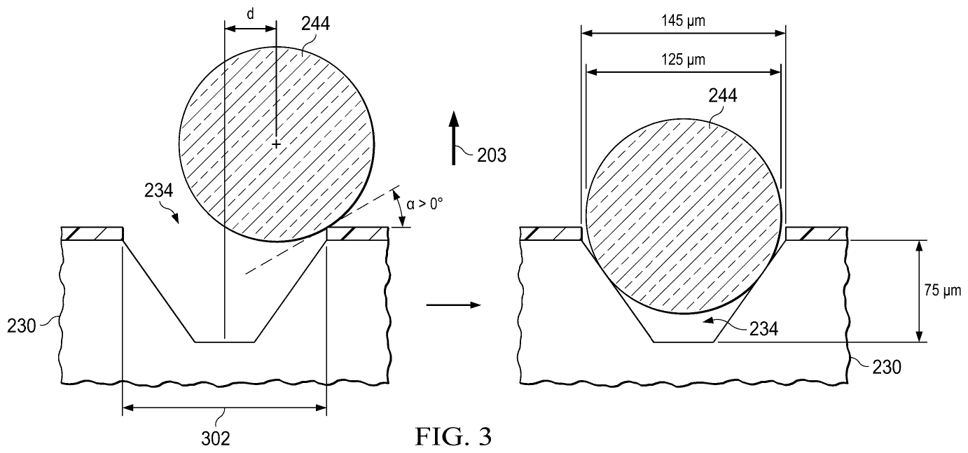

FIG. 3 schematically illustrates a capture of a microsphere 244 in the respective V-shaped groove 234 according to some examples. The illustrated capture occurs during the engagement of the portions 201 and 202 of the connector 200 illustrated in FIG. 2. The GCLA 250 to which the microsphere 244 is glued is not explicitly shown in FIG. 3 for clarity of depiction. The indicated sizes are for illustration purposes only and are not intended to be limiting. Based on the provided description, a person of ordinary skill in the pertinent art will readily understand how to select optimal sizes of the grooves and microspheres to achieve target alignment parameters without any undue experimentation. Example dimensions shown in FIG. 3 are for illustration purposes and should not be construed as limiting possible alternative implementations.

For the illustrated capture to occur, the microsphere 244 needs to hit the groove 234 within a capture range 302. The coarse alignment feature 212/240 of the connector 200 is specifically sized and designed to enable the microsphere 244 to be positioned within the capture range 302 when the pin 212 is inserted into the hole 242 as illustrated in FIG. 2. Once the microsphere 244 is within the capture range 302, e.g., as illustrated in the left portion of FIG. 3, further movement of the FALA 230 along the direction 203 will cause the microsphere 244 to slide into the centered position within the groove 234 as illustrated in the right portion of FIG. 3. The capture range 302 can be understood as the initial offset allowance between the FALA 230 and the GCLA 250. In some design examples, a relatively large capture range 302 may be favored because it can relax the tolerances of the corresponding parts and the assembly process.

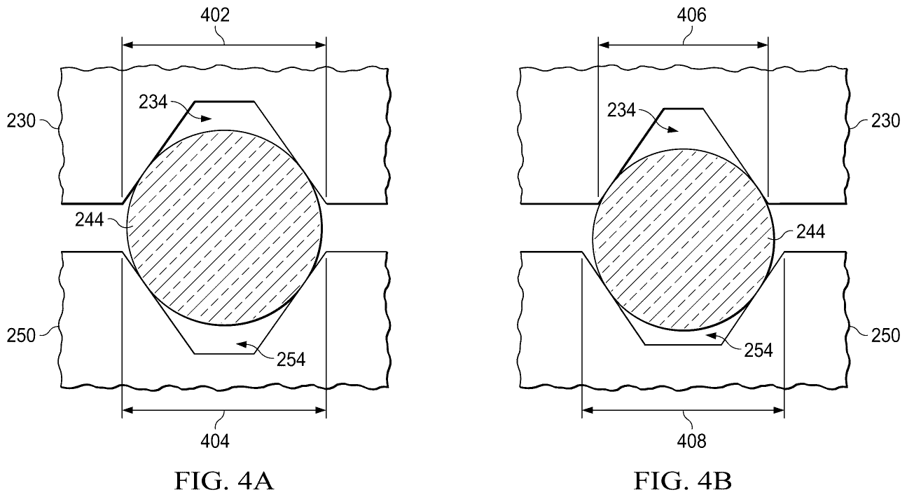

FIGS. 4A-4B schematically illustrate symmetric and asymmetric mating, respectively, that can be implemented in the connector 200 according to some examples. In the examples shown, the microsphere 244 is epoxied to the FALA 230 and is detachable from the GCLA 250. In the example of symmetric mating between the FALA 230 and the GCLA 250 illustrated in FIG. 4A, a lateral size 402 of the groove 234 is the same as a lateral size 404 of the groove 254. In the example of asymmetric mating between the FALA 230 and the GCLA 250 illustrated in FIG. 4B, a lateral size 406 of the groove 234 is different from a lateral size 408 of the groove 254. In the latter example, the lateral size 408 is greater than the lateral size 406. A benefit of this type of asymmetric mating is to increase the capture range for the detachable (from the microsphere) side of the connector 200.

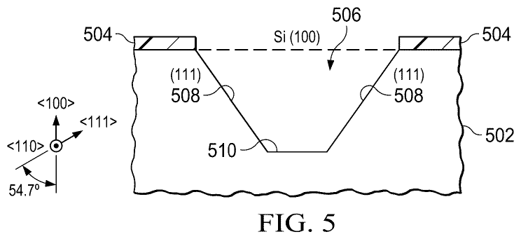

FIG. 5 is a schematic diagram illustrating a cross-sectional side view of a groove 506 used to implement the V-shaped grooves 234, 254 according to some examples. The groove 506 is made in a crystalline Si substrate 502 such that the walls of the groove 506 are parallel to certain crystallographic planes of the silicon crystal material of the substrate 502. For example, a side wall 508 of the groove 506 is parallel to the (111) crystallographic plane of the substrate 502. A bottom wall 510 of the groove 506 is similarly parallel to the (100) crystallographic plane of the substrate 502.

In the examples shown, the groove 506 is anisotropically etched into single crystal silicon using a photolithographically defined etch-resistant mask 504 deposited on the surface of substrate 502. The width of the groove 506 is determined by the size of the corresponding opening in the mask 504. The depth of the groove 506 is determined by the process control of the anisotropic silicon etch. The (111) planes (where the respective microsphere 244 will be seated) may be considered to have a relatively high-quality surface, e.g., due to better smoothness and lower defect density compared to some other silicon planes. As a result, as long as the microsphere 244 is placed within the top opening of the groove 506, it will naturally slide toward the bottom wall of the groove 506 with high placement accuracy.

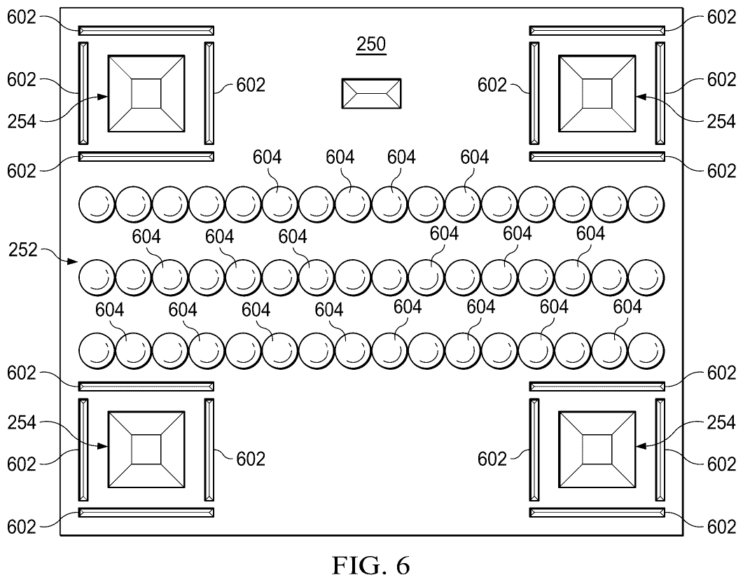

FIG. 6 is a schematic diagram illustrating a plan view of the GCLA 250 according to some examples. In the example shown, the lens array 252 of the GCLA 250 includes forty-eight individual lenses 604 arranged in three rows, with each row having a respective linear array of sixteen lenses. The GCLA 250 also has four V-shaped grooves 254, each implemented using a respective instance of the groove 506 (also see FIG. 5). As previously mentioned, in some embodiments of the connector 200, each of the grooves 254 may have a respective microsphere 244 glued therein. To prevent spillage of the glue fluid onto the lens array 252 and/or other sensitive areas of the GCLA 250 during the gluing process, the GCLA 250 has trench grooves 602 configured to catch the spilling glue, thereby containing the spillage thereof within a designated area defined by the geometric shape and arrangement of the trench grooves 602. In the example shown, four trench grooves 602 are arranged in a rectangular pattern around the corresponding groove 254. In other examples, other suitable arrangements of the trench grooves 602 may also be used.

In embodiments of the connector 200, in which the microspheres 244 are glued in the grooves 234 of the FALA 230 (e.g., as indicated in FIGS. 4A-4B), a groove arrangement similar to that illustrated in FIG. 6 can be implemented in the FALA 230.

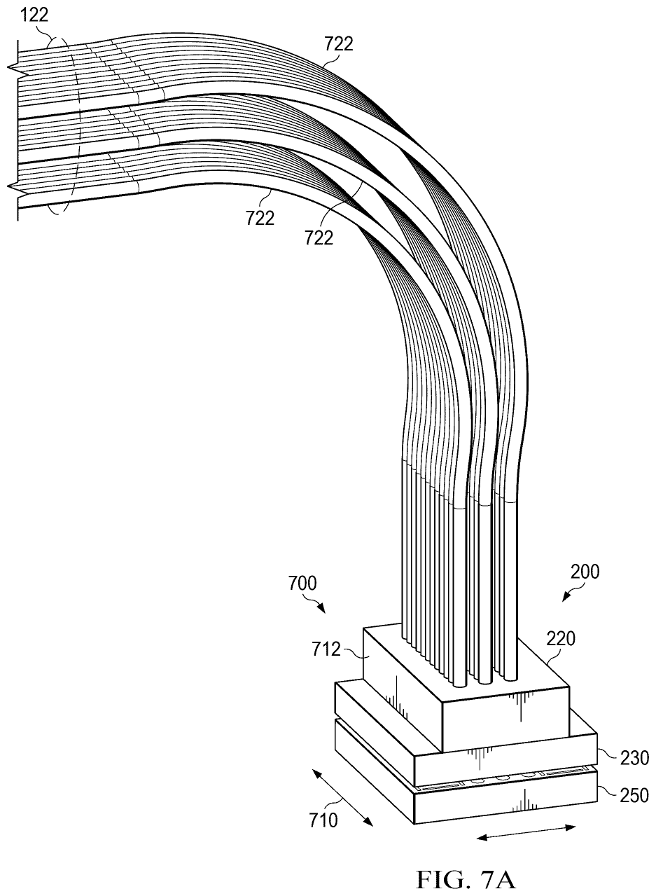

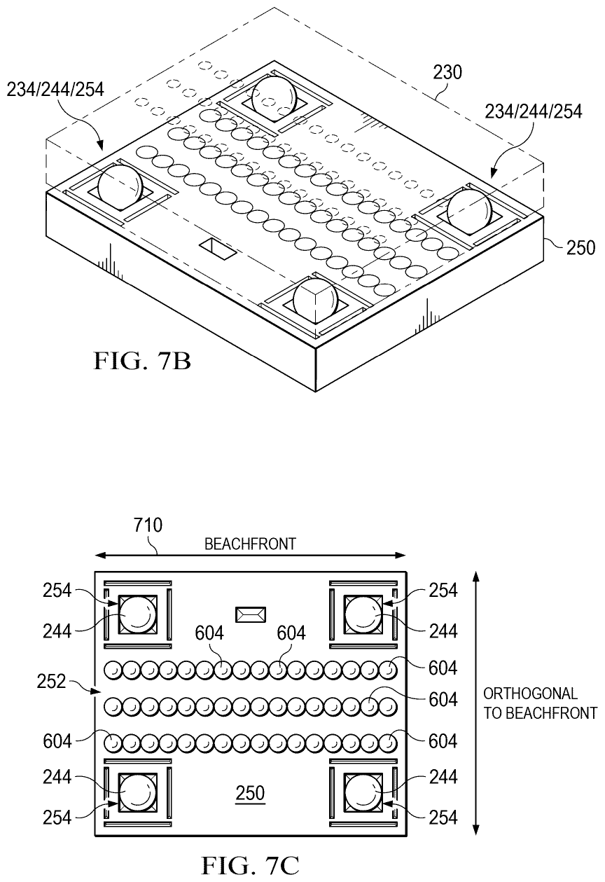

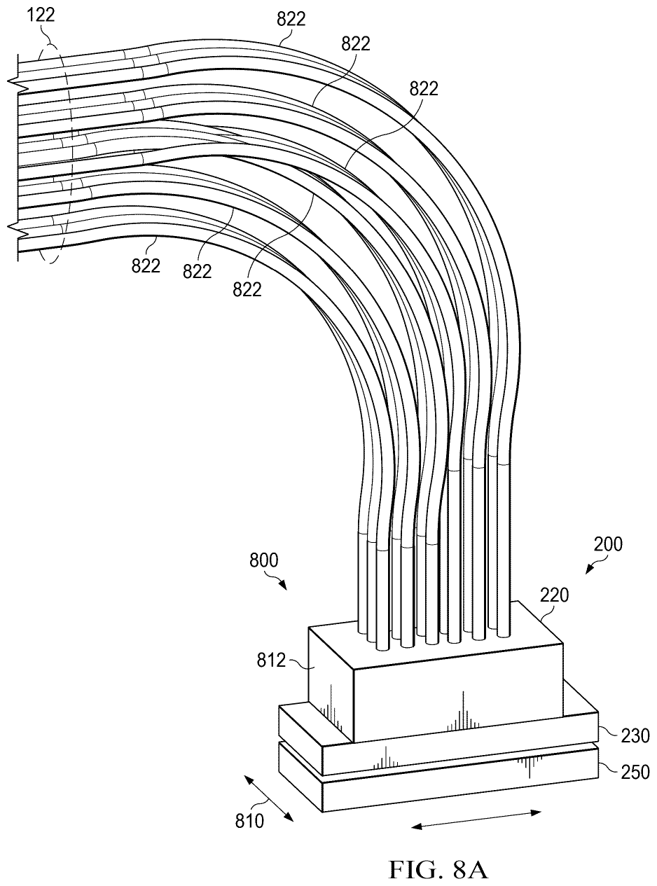

FIGS. 7A-7C pictorially illustrate a cable escape scenario implemented with the connector 200 according to some examples. More specifically, FIG. 7A is a schematic diagram illustrating a perspective view of a portion 700 of the connector 200 with attached fiberoptic cables 122. FIG. 7B is a schematic diagram illustrating a perspective view of the FALA 230 and the GCLA 250 used in the portion 700. FIG. 7C is a schematic diagram illustrating a plan view of the GCLA 250 used in the portion 700.

In the example shown, the fiberoptic cables 122 are arranged in three bundles 722, each including sixteen optical fibers optically coupled to a respective row of lenses 604 in the lens array 252 of the GCLA 250 (see FIGS. 7A, 7C). The three rows of lenses 604 are parallel to a beachfront direction 710 (see FIGS. 7A, 7C). The fiberoptic cables 122 are escaped from a long side 712 of the FAU 220, which is also parallel to the beachfront direction 710. The locations of the fine alignment features 234/244/254 on FALA 230 and the GCLA 250 are selected such as to save substantially all of the beachfront real estate for the rows of lenses 604 (see FIGS. 7B, 7C). As a result, the density of fiberoptic cables 122 per unit length of the beachfront along which the fiberoptic connectors 120 are located in the IC assembly 100 is substantially maximized (also see FIG. 1).

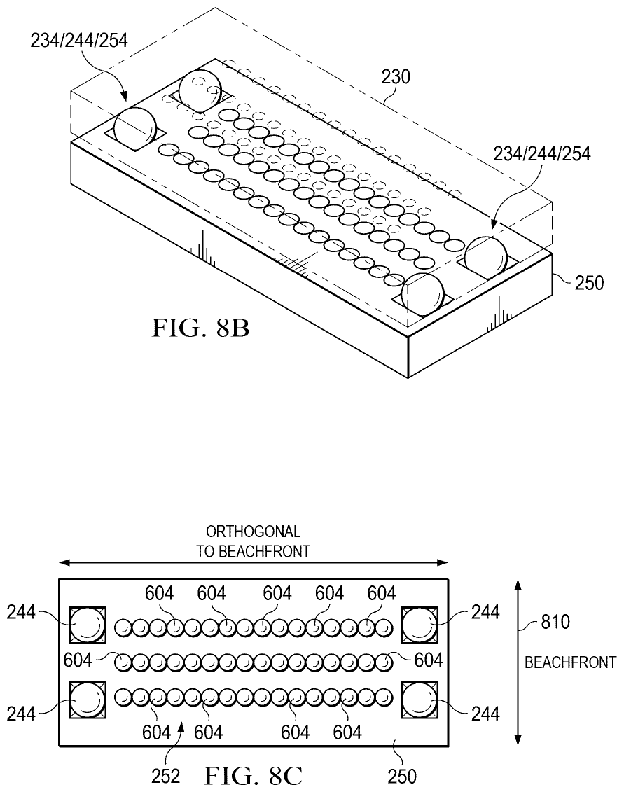

FIGS. 8A-8C pictorially illustrate another cable escape scenario implemented with the connector 200 according to some additional examples. More specifically, FIG. 8A is a schematic diagram illustrating a perspective view of a portion 800 of the connector 200 with attached fiberoptic cables 122. FIG. 8B is a schematic diagram illustrating a perspective view of the FALA 230 and the GCLA 250 used in the portion 800. FIG. 8C is a schematic diagram illustrating a plan view of the GCLA 250 used in the portion 800.

In the example shown, fiberoptic cables 122 are arranged in a plurality of bundles 822, each including three optical fibers optically coupled to a respective column of lenses 604 in the lens array 252 of the GCLA 250 (see FIGS. 8A, 8C). The lenses 604 are arranged in sixteen columns and three rows. The columns of lenses 604 are parallel to a beachfront direction 810 (see FIGS. 8A, 8C). The fiberoptic cables 122 are escaped from a short side 812 of the FAU 220. The locations of the fine alignment features 234/244/254 on FALA 230 and the GCLA 250 are selected such as to save substantially all of the beachfront real estate for the columns of lenses 604 (see FIGS. 8B, 8C). As a result, the density of fiberoptic cables 122 per unit length of the beachfront along which eight fiberoptic connectors 120 are located in the IC assembly 100 is substantially maximized (also see FIG. 1).

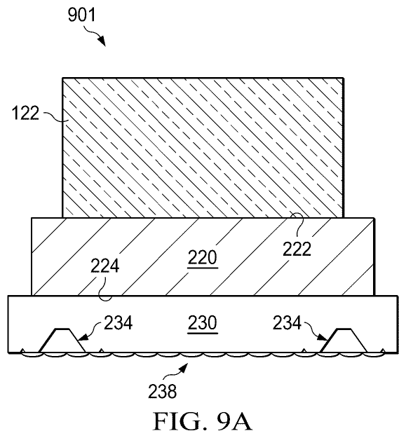

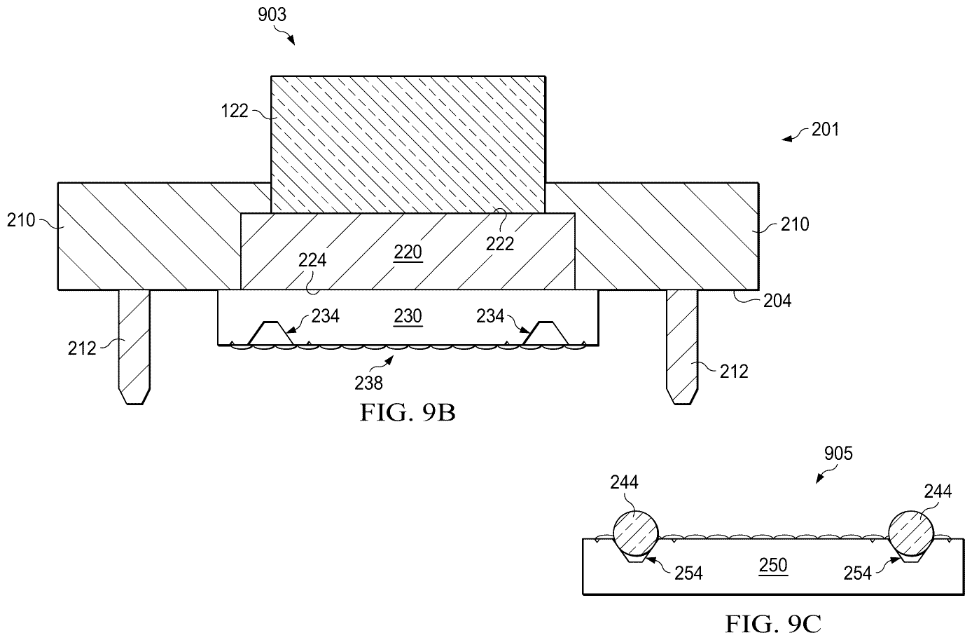

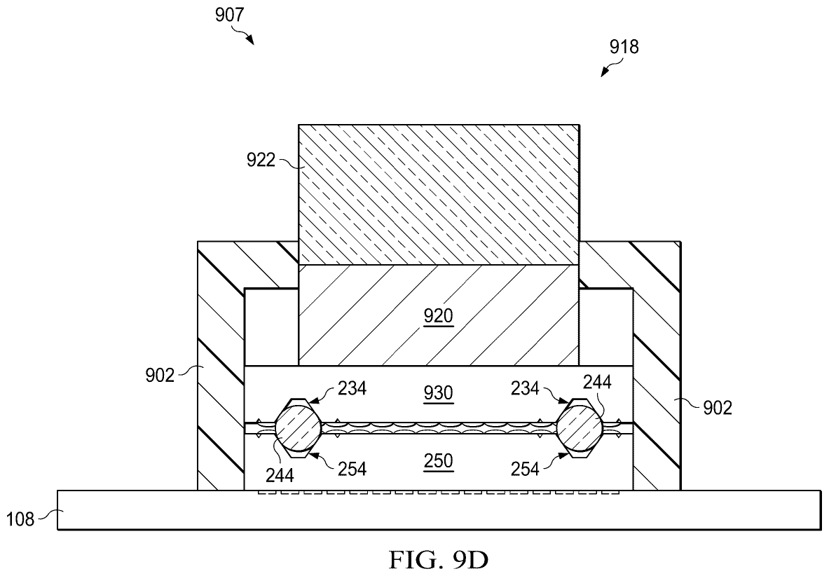

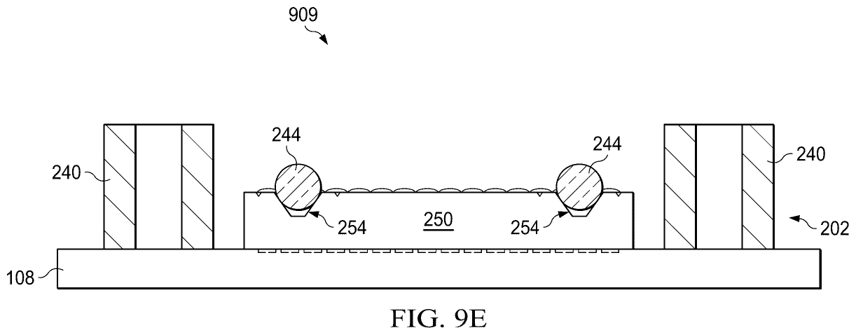

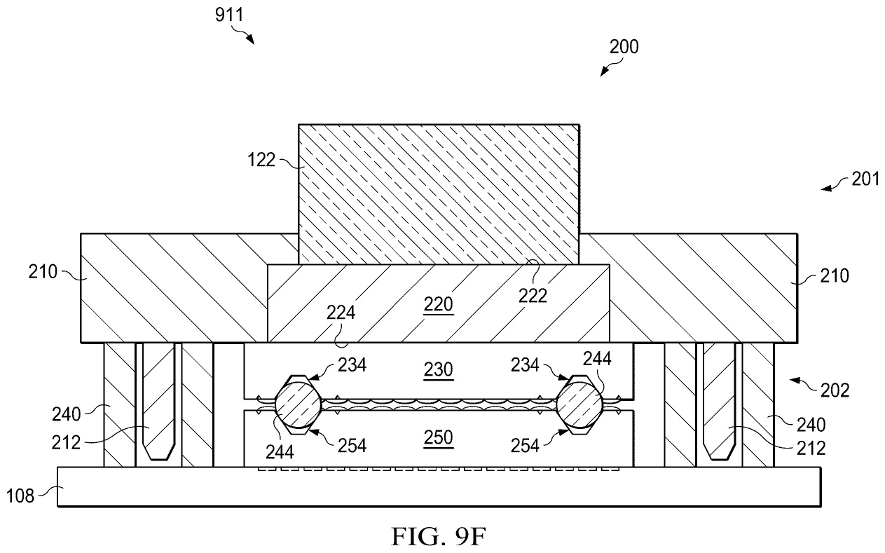

FIGS. 9A-9F pictorially illustrate a process flow for assembling the connector 200 according to some examples. More specifically, FIGS. 9A, 9B illustrate the process flow for assembling the plug portion 201 of the connector 200. FIGS. 9C, 9D similarly illustrate the process flow for assembling the socket portion 202 of the connector 200. FIG. 9E illustrates the step of connecting the plug portion 201 and the socket portion 202.

A step 901 illustrated in FIG. 9A includes active optical alignment of the lens array 238 of the FALA 230 to the optical fibers 122 connected to the FAU 220. As used herein, the term “active optical alignment” refers to a high-precision manufacturing process that uses real-time optical feedback to position components within an optical system. Unlike passive alignment, which relies on fixed mechanical tolerances, active alignment involves monitoring a live signal, such as optical power, beam intensity, or image clarity, and iteratively adjusting the components until peak performance is achieved. In a representative example, specialized robotic positioning systems are used to move the components through multiple degrees of freedom (e.g., X, Y, Z translation, pitch, yaw, and roll). An electronic controller programmed to use a suitable optimization algorithm, such as a gradient search, operates to control the movement(s) to maximize a monitoring signal and find an optimal alignment. In the step 901 illustrated in FIG. 9A, the FAU 220 may be moved with respect to the FALA 230 in this manner until the optimal alignment is found. The FAU 220 and the FALA 230 are then fixedly attached to one another.

A step 903 illustrated in FIG. 9B includes attaching the frame 210 with pins 212 to the FCU (which comprises the FAU 220 and the fibers 122). Operations of the step 903 complete the assembly of the plug portion 201.

A step 905 illustrated in FIG. 9C includes passively attaching the plurality of microspheres 244 into the corresponding V-grooves 254 on the 250 GCLA. In some examples, the glue used for performing this attachment is an epoxy glue. After the glue is cured, the microspheres 244 become fixedly attached to the 250 GCLA.

A step 907 illustrated in FIG. 9D includes active optical alignment of the GCLA 250 to the photonic chiplet (PIC) 108. This active optical alignment includes the use of a “golden” plug portion 918. The golden plug portion 918 is a standard or reference unit that is made with high geometrical and optical accuracy and includes a golden FCU 920 with fibers 922 and a golden FALA 930. The golden plug portion 918 is placed onto the GCLA unit 250/244 produced during the step 905 such that the fine alignment features of the golden FALA 930 and the GCLA 250 are engaged via the microspheres 244. A grabber 902 is then used to grab together the golden plug portion 918 and the GCLA 250 so engaged and place them onto the photonic chiplet 108. The grabber 902 is then used to move the golden plug portion 918 and the GCLA 250 relative to the photonic chiplet 108 until an optimal relative position is found via active optical alignment. The GCLA 250 and the photonic chiplet 108 are then fixedly attached to one another in that position. After the glue is cured, the grabber 902 is operated to release the GCLA 250 and remove the golden plug portion 918.

A step 909 illustrated in FIG. 9E includes fixedly attaching the pin guides 240 to the photonic chiplet 108. In some examples, the attachment is performed using passive alignment based on manufacturing tolerances. In some other examples, the attachment may alternatively be performed using active optical alignment. Operations of the step 909 complete the assembly of the socket portion 202.

A step 911 illustrated in FIG. 9E includes attaching the plug portion 201 obtained in the step 903 to the socket portion 202 obtained in the step 909. Operations of the step 911 include engaging the coarse alignment feature 212/240 of the connector portions 201, 202, e.g., as described above in reference to FIG. 2. This engagement brings the connector portions 201, 202 to within the capture range (e.g., 302, FIG. 3) of the fine alignment feature 234/244/254. Operations of the step 911 further include: (i) engaging the fine alignment feature 234/244/254 and (ii) fixing the connector portions 201, 202 in that engaged position, e.g., using the above-mentioned holding mechanism of the connector 200. The holding mechanism (not explicitly shown in FIG. 9F for clarity of depiction; see FIG. 12) can be released when needed to separate the plug portion 201 and the socket portion 202 from one another. The plug portion 201 and the socket portion 202 can thereafter be reconnected by repeating the above-described operations of the step 911.

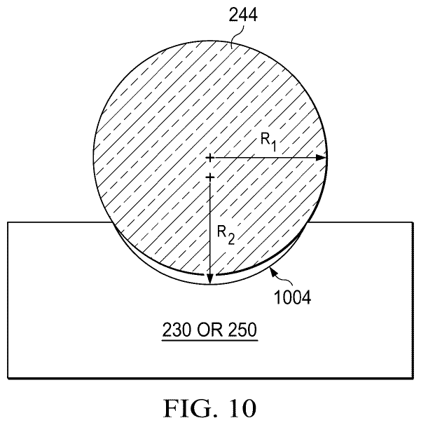

FIG. 10 is a schematic diagram illustrating an alternative groove shape used in the connector 200 according to some examples. In the example shown, a groove 1004 in the FALA 230 or the GCLA 250 has a spherical shape characterized by a radius R₂. The microsphere 244 has a radius R₁, which is greater than R₂. In other examples, the value of R₂ can be the same as or greater than the value of R_{1.}

In additional embodiments of the connector 200, other alternative groove shapes can also be used. A preferred groove shape may have one or more of the following characteristics: (i) has a concave shape; (ii) provides a single (e.g., unique) stable position for the corresponding microsphere 244 to settle in when the microsphere is placed into the groove; and (iii) has a capture range consistent with the dimensions of the coarse alignment feature used in the corresponding detachable fiberoptic connector.

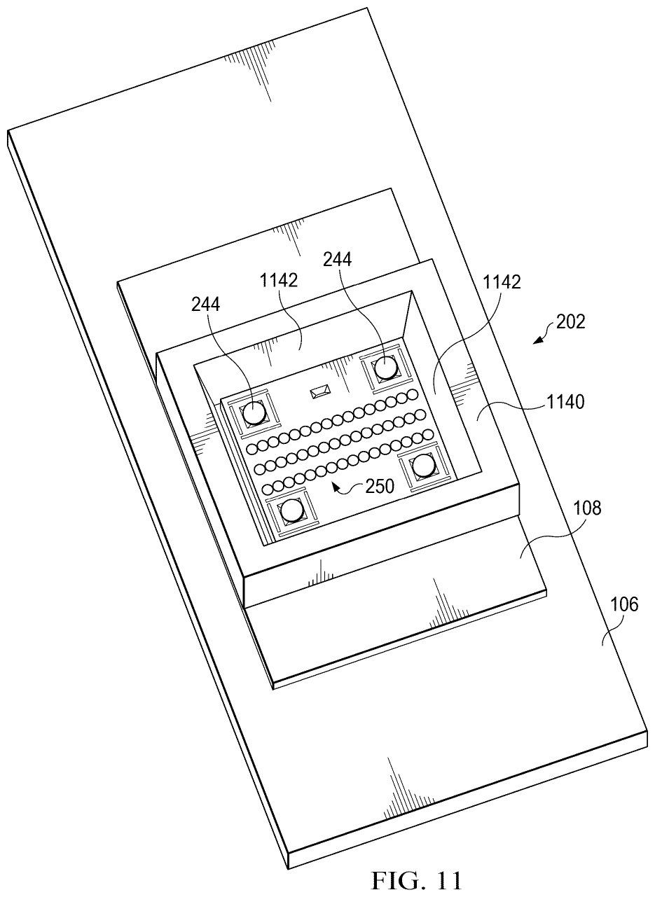

FIG. 11 is a schematic diagram illustrating an alternative geometric shape for the coarse alignment feature used in the connector 200 according to some examples. More specifically, FIG. 11 shows a 3D perspective view illustrating a modified socket portion 202 of the connector 200. The modification with respect to the example shown in FIG. 2 includes replacing the pin guides 240 by a frame 1140. Interior surfaces 1142 of the frame 1140 have a geometric shape designed to guide the plug portion 201 of the connector 200 into the capture range of the fine alignment feature 234/244/254. In particular, slanted/chamfered portions of the surfaces 1142, when contacted by the corresponding exterior surfaces of the plug portion 201, operate to guide the plug portion 201 into a more centered position from which the fine alignment feature 234/244/254 takes over to place the FALA 230 and the GCLA 250 into the final mated position. In this particular embodiment, no pins 212 are needed as the frame 1140 is designed to engage and directly interact with the exterior surfaces of the FALA/FAU assembly.

FIGS. 12A-12C schematically illustrate a detachable fiberoptic connector 1200 including a holding mechanism according to some examples. More specifically, FIG. 12A is a schematic diagram illustrating a 3D perspective view of a plug portion 1201 of the connector 1200. FIG. 12B is a schematic diagram illustrating a cross-sectional side view of the connector 1200 when the plug portion 1201 and a corresponding socket portion 1202 are in a partially disconnected state. FIG. 12C is a schematic diagram illustrating a cross-sectional side view of the connector 1200 when the plug and socket portions 1201, 1202 are in a connected state.

In the example shown, the plug portion 1201 of the connector 1200 includes the FALA 230 and the FAU 220 connected to the optical fibers 122 (see FIG. 12A). The plug portion 1201 further includes a molded-plastic shell 1210 including latching tabs 1212 on opposite sidewalls thereof (see FIGS. 12A, 12B). The plug portion 1201 also has side openings 1222 configured to accommodate the flexing of the latching tabs 1212 (see FIGS. 12A, 12B).

In the example shown, the socket portion 1202 of the connector 1200 includes a socket portion 1202 including a frame 1240 having slanted surfaces 1242 (see FIGS. 12B, 12C). The frame 1240 may be functionally similar to the frame 1140 illustrated in FIG. 11. The socket portion 1202 of the connector 1200 further includes a strike body 1250 that is fixedly attached to the photonic chiplet 108 (see FIG. 12B). The strike body 1250 has side holes 1252 configured to receive the latching tabs 1212 (see FIG. 12C).

To connect the plug portion 1201 to the socket portion 1202, the plug portion 1201 is moved toward the socket portion 1202 in a direction 1203 as indicated in FIG. 12B. Along the movement trajectory, the following events happen in sequence: (i) the slanted surfaces 1242 of the frame 1240, when contacted by the corresponding exterior surfaces of the plug portion 1201, operate to guide the plug portion 1201 into a capture range of the fine alignment feature of the connector 1200; (ii) the fine alignment feature operates to place the FALA 230 and the GCLA 250 into the aligned position; and (iii) the latching tabs 1212 snap into the strike holes 1252 to hold the FALA 230 and the GCLA 250 in the aligned position as indicated in FIG. 12C.

To disconnect the plug portion 1201 from the socket portion 1202, the latching tabs 1212 are pushed inwards until they clear the edges of the strike holes 1252. An external pull force 1205 applied to the molded-plastic shell 1210 then causes the molded-plastic shell 1210 to come out of the strike body 1250, which enables subsequent manual removal of the plug portion 1201 from the socket portion 1202 along the direction opposite to the direction 1203 (see FIGS. 12B, 12C).

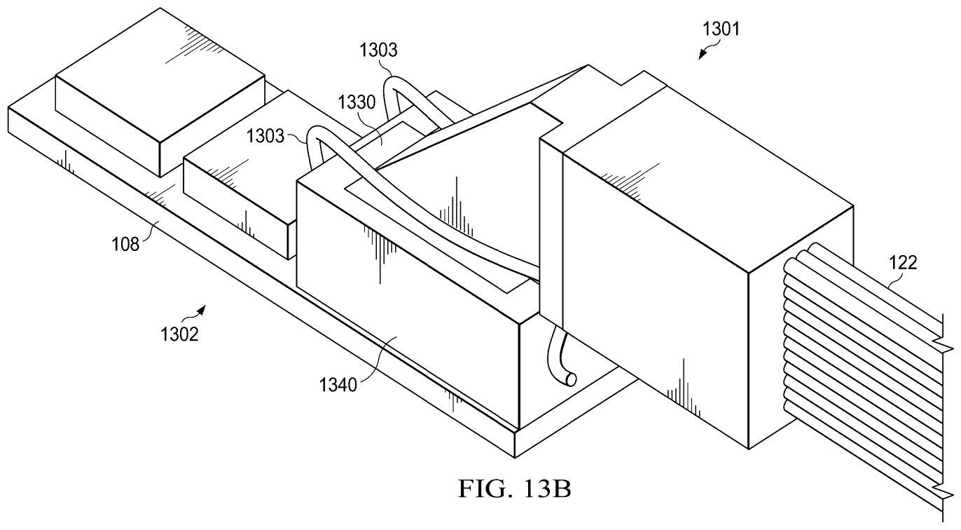

FIGS. 13A-13B schematically illustrate a detachable fiberoptic connector 1300 with a holding mechanism according to some additional examples. More specifically, FIG. 13A is a schematic diagram illustrating a 3D perspective view of a plug portion 1301 and a socket portion 1302 of the connector 1300 in a disconnected state. FIG. 13B is a schematic diagram illustrating a 3D perspective view of the connector 1300 in a connected state.

A coarse alignment feature of the connector 1300 includes a frame 1340 in the socket portion 1302 and a matching insert 1330 in the plug portion 1301. An inner opening 1338 of the frame 1340 has four prismatic cutouts 1336 on the generally vertical sidewalls thereof. Only two of the four prismatic cutouts 1336 are directly visible in the view shown in FIG. 13A. The complementary shape to a cutout 1336 is a triangular prism oriented such that its triangular bases are substantially orthogonal to the main plain of the photonic chiplet 108, with the vertices of the triangular bases of the prism pointing down toward the photonic chiplet 108 as indicated in FIG. 13A. The insert 1330 has four triangular prisms 1334 attached to the sidewalls thereof, with the four triangular prisms 1334 being shaped such as to complementarily mate with the four prismatic cutouts 1336 of the frame 1340. Only one of the four triangular prisms 1334 is fully visible on the view shown in FIG. 13A. The pointing-down orientation of the triangular prisms 1334 and the prismatic cutouts 1336 enables the frame 1340 of the socket portion 1302 to guide the insert 1330 into a capture range of the fine alignment feature of the connector 1300 when the plug portion 1301 is being pushed into the inner opening 1338 of the socket portion 1302. In some examples, the coarse alignment prism surfaces are not in contact once the final connection is made. Once the fine alignment feature of the connector 1300 is engaged, spring brackets 1303 of the holding mechanism are placed over the frame 1340 and the insert 1330 to secure the plug and socket portions 1301, 1302 of the connector 1300 in the connected state illustrated in FIG. 13B. To disconnect the plug and socket portions 1301, 1302, the spring brackets 1303 are removed first and then the plug portion 1301 is pulled out of the opening 1336, e.g., to return the plug and socket portions 1301, 1302 to the disconnected state illustrated in FIG. 13A.

According to an example embodiment disclosed above, e.g., in the summary section and/or in reference to any one or any combination of some or all of FIGS. 1-13, provided is a fiberoptic connector comprising: a plug portion including a fiber array lens array (FALA) connected to a plurality of optical fibers; a socket portion including a photonic coupler lens array (PCLA) optically coupled to a photonic chiplet; a coarse alignment feature having a first component in the plug portion and a second component in the socket portion; and a fine alignment feature including a first sphere fixedly attached to one of the FALA and the PCLA and further including a first groove in another one of the FALA and the PCLA, wherein the first and second components are configured to bring the first sphere into a capture range of the first groove when the plug portion is inserted into the socket portion; and wherein, when within the capture range, the first groove is configured to guide the first sphere into a stable position within the first groove to achieve an optically aligned state for the FALA and the PCLA in which the plurality of optical fibers is optically coupled to a corresponding plurality of grating couplers in the photonic chiplet.

In some embodiments of the above fiberoptic connector, the first sphere is fixedly attached in a second groove, the second groove being in the FALA; and wherein the first groove is in the PCLA.

In some embodiments of any of the above fiberoptic connectors, the FALA has one or more trench grooves next to the second groove, the one or more trench grooves being configured to catch an overflow of adhesive used to fixedly attach the first sphere in the second groove.

In some embodiments of any of the above fiberoptic connectors, the first sphere is fixedly attached in a second groove, the second groove being in the PCLA; and wherein the first groove is in the FALA.

In some embodiments of any of the above fiberoptic connectors, the PCLA has one or more trench grooves next to the second groove, the one or more trench grooves being configured to catch an overflow of adhesive used to fixedly attach the first sphere in the second groove.

In some embodiments of any of the above fiberoptic connectors, the first groove has a concave shape having a unique stable position for the first sphere.

In some embodiments of any of the above fiberoptic connectors, the first groove is V-shaped.

In some embodiments of any of the above fiberoptic connectors, the first groove is in a layer of crystalline silicon; and wherein a first facet of the first groove is parallel to a (111) crystallographic plane of the crystalline silicon.

In some embodiments of any of the above fiberoptic connectors, a second facet of the first groove is parallel to a (100) crystallographic plane of the crystalline silicon.

In some embodiments of any of the above fiberoptic connectors, the first sphere comprises a material selected from the group consisting of glass, fused silica, zirconia, ceramic, alumina, silicon nitride, and polymer.

In some embodiments of any of the above fiberoptic connectors, the first sphere is one of a plurality of spheres fixedly attached to said one of the FALA and the PCLA; and wherein the first groove is one of a plurality of grooves in said another one of the FALA and the PCLA, the plurality of grooves hosting the plurality of spheres.

In some embodiments of any of the above fiberoptic connectors, the first component includes a first pin; and wherein the second component includes a first pin guide configured to mate with the first pin.

In some embodiments of any of the above fiberoptic connectors, the first component further includes a second pin; wherein the second component further includes a second pin guide configured to mate with the second pin; and wherein a plane passing through a center axis of the first pin guide and a center axis of the second pin guide is substantially orthogonal (e.g., to within ±5° or ±10°) to a beachfront direction of the photonic chiplet.

In some embodiments of any of the above fiberoptic connectors, the plug portion has a substantially rectangular footprint having a long side and a short side; wherein, in the optically aligned state, the long side of the footprint is substantially parallel (e.g., to within ±5° or ±10°) to the beachfront direction; and wherein the plurality of optical fibers is escaped from the fiberoptic connector over the long side of the footprint.

In some embodiments of any of the above fiberoptic connectors, the plug portion has a substantially rectangular footprint having a long side and a short side; wherein, in the optically aligned state, the short side of the footprint is substantially parallel (e.g., to within ±5° or ±10°) to the beachfront direction; and wherein the plurality of optical fibers is escaped from the fiberoptic connector over the short side of the footprint.

In some embodiments of any of the above fiberoptic connectors, the first component includes a sidewall of the FALA; and wherein the second component includes a bracket, a frame, and/or a surface configured to guide the sidewall of the FALA to direct the first sphere into the capture range of the first groove.

According to another example embodiment disclosed above, e.g., in the summary section and/or in reference to any one or any combination of some or all of FIGS. 1-13, provided is a method for manufacturing a fiberoptic connector, the method comprising: assembling a plug portion of the fiberoptic connector, the plug portion comprising a first component of a coarse alignment feature of the fiberoptic connector, wherein the assembling includes connecting a fiber array lens array (FALA) to a plurality of optical fibers; making a socket portion of the fiberoptic connector, the socket portion comprising a second component of the coarse alignment feature of the fiberoptic connector, wherein the making includes attaching a photonic coupler lens array (PCLA) to a photonic chiplet such that a plurality of lenses of the PCLA is optically coupled to a corresponding plurality of grating couplers in the photonic chiplet; and gluing a first sphere to one of the FALA and the PCLA, wherein another one of the FALA and the PCLA has a first groove configured to register with the first sphere, wherein the first and second components are configured to bring the first sphere into a capture range of the first groove when the plug portion is inserted into the socket portion; and wherein, when within the capture range, the first groove is configured to guide the first sphere into a stable position within the first groove to achieve an optically aligned state for the FALA and the PCLA in which the plurality of optical fibers is optically coupled to the corresponding plurality of grating couplers.

In some embodiments of the above method, the attaching is performed after optically aligning the PCLA with the corresponding plurality of grating couplers in the photonic chiplet using a golden plug portion.

In some embodiments of any of the above methods, the method further comprises forming the first groove in a layer of crystalline silicon using anisotropic etching, wherein a first facet of the first groove is parallel to a (111) crystallographic plane of the crystalline silicon; and wherein a second facet of the first groove is parallel to a (100) crystallographic plane of the crystalline silicon.

In some embodiments of any of the above methods, the gluing comprises catching an overflow of adhesive in one or more trench grooves located next to a site of the first sphere in said one of the FALA and the PCLA.

According to yet another example embodiment disclosed above, e.g., in the summary section and/or in reference to any one or any combination of some or all of FIGS. 1-13, provided is a fiberoptic connector comprising: a plug portion including a fiber array lens array (FALA) connected to a plurality of optical fibers; a socket portion including a photonic coupler lens array (PCLA) optically coupled to a photonic chiplet; a coarse alignment feature having a first component in the plug portion and a second component in the socket portion; and a fine alignment feature including a protrusion (e.g., a bump fixedly attached to and) extending from one of the FALA and the PCLA and further including a first groove in another one of the FALA and the PCLA, wherein the first and second components are configured to bring the fixed protrusion into a capture range of the first groove when the plug portion is inserted into the socket portion; and wherein, when within the capture range, the first groove is configured to guide the protrusion into a stable position within the first groove to achieve an optically aligned state for the FALA and the PCLA in which the plurality of optical fibers is optically coupled to a corresponding plurality of photonic components in the photonic chiplet.

In some embodiments of the above fiberoptic connector, the corresponding plurality of photonic components includes one or more components selected from the group consisting of a grating coupler, a turning mirror, a photodetector, and a laser.

According to yet another example embodiment disclosed above, e.g., in the summary section and/or in reference to any one or any combination of some or all of FIGS. 1-13, provided is a fiberoptic connector comprising: a plug portion including a first lens array element connected to a plurality of optical fibers; a socket portion including a second lens array optically coupled to a photonic chiplet; a first alignment feature including a first sphere fixedly attached to one of the plug portion and the socket portion and further including a first groove in another one of the plug portion and the socket portion, wherein the first groove is configured to guide the first sphere into a stable position within the first groove to achieve an optically aligned state for the first and second lens arrays in which the plurality of optical fibers is optically coupled to a corresponding plurality of photonic components in the photonic chiplet.

In some embodiments of any of the above fiberoptic connectors, the corresponding plurality of photonic components includes one or more components selected from the group consisting of a grating coupler, a turning mirror, a photodetector, and a laser.

In some embodiments of any of the above fiberoptic connectors, the first sphere is fixedly attached in a second groove, the second groove being in the first lens array; and wherein the first groove is in the second lens array.

In some embodiments of any of the above fiberoptic connectors, the first sphere is fixedly attached in a second groove, the second groove being in the second lens array; and wherein the first groove is in the first lens array.

In some embodiments of any of the above fiberoptic connectors, the first groove has a concave shape having a unique stable position for the first sphere.

In some embodiments of any of the above fiberoptic connectors, the first groove is V-shaped.

In some embodiments of any of the above fiberoptic connectors, the first groove is in a layer of crystalline silicon; and wherein a first facet of the first groove is parallel to a (111) crystallographic plane of the crystalline silicon.

In some embodiments of any of the above fiberoptic connectors, a second facet of the first groove is parallel to a (100) crystallographic plane of the crystalline silicon.

In some embodiments of any of the above fiberoptic connectors, the first sphere comprises a material selected from the group consisting of glass, fused silica, zirconia, ceramic, alumina, silicon nitride, metal, metal alloy, and polymer.

In some embodiments of any of the above fiberoptic connectors, the first sphere is one of a plurality of spheres fixedly attached to said one of the first and second lens arrays; and wherein the first groove is one of a plurality of grooves in said another one of the first and second lens arrays, the plurality of grooves hosting the plurality of spheres.

In some embodiments of any of the above fiberoptic connectors, the fiberoptic connector further comprises a second alignment feature having a first component in the plug portion and a second component in the socket portion, wherein the first and second components are configured to bring the first sphere into a capture range of the first groove when the plug portion is inserted into the socket portion.

In some embodiments of any of the above fiberoptic connectors, the first component includes a first pin; and wherein the second component includes a first pin guide configured to mate with the first pin.

In some embodiments of any of the above fiberoptic connectors, the first component further includes a second pin; wherein the second component further includes a second pin guide configured to mate with the second pin; and wherein a plane passing through a center axis of the first pin guide and a center axis of the second pin guide is substantially orthogonal to a beachfront direction of the photonic chiplet.

In some embodiments of any of the above fiberoptic connectors, the plug portion has a substantially rectangular footprint having a long side and a short side; wherein, in the optically aligned state, the long side of the footprint is substantially parallel to the beachfront direction; and wherein the plurality of optical fibers is escaped from the fiberoptic connector over the long side of the footprint.

In some embodiments of any of the above fiberoptic connectors, the plug portion has a substantially rectangular footprint having a long side and a short side; wherein, in the optically aligned state, the short side of the footprint is substantially parallel to the beachfront direction; and wherein the plurality of optical fibers is escaped from the fiberoptic connector over the short side of the footprint.

In some embodiments of any of the above fiberoptic connectors, the first component includes a sidewall of the first lens array; and wherein the second component includes a surface configured to guide the sidewall such as to direct the first sphere into the capture range of the first groove.

According to yet another example embodiment disclosed above, e.g., in the summary section and/or in reference to any one or any combination of some or all of FIGS. 1-13, provided is a method for manufacturing a fiberoptic connector comprising: assembling a plug portion of the fiberoptic connector, wherein the assembling includes connecting a first lens array to a plurality of optical fibers; making a socket portion of the fiberoptic connector, wherein the making includes attaching a second lens array to a photonic chiplet such that a plurality of lenses of the second lens array is optically coupled to a corresponding plurality of photonic components in the photonic chiplet; and gluing a first sphere to one of the first and second lens arrays, wherein another one of the first and second lens arrays has a first groove configured to register with the first sphere, wherein the first groove is configured to guide the first sphere into a stable position within the first groove to achieve an optically aligned state for the first and second lens arrays in which the plurality of optical fibers is optically coupled to the corresponding plurality of photonic components.

In some embodiments of any of the above methods, the attaching is performed after optically aligning the second lens array with the corresponding plurality of photonic components in the photonic chiplet using a golden plug portion.

In some embodiments of any of the above methods, the method further comprises forming the first groove in a layer of crystalline silicon using anisotropic etching, wherein a first facet of the first groove is parallel to a (111) crystallographic plane of the crystalline silicon; and wherein a second facet of the first groove is parallel to a (100) crystallographic plane of the crystalline silicon.

In some embodiments of any of the above methods, the gluing comprises catching an overflow of adhesive in one or more trench grooves located next to a site of the first sphere in said one of the first and second lens arrays.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding FIG.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The modifier “about” or “approximately” used in connection with a quantity is inclusive of the stated value and has the meaning dictated by the context (for example, it includes at least the degree of error associated with the measurement of the particular quantity). The modifier “about” or “approximately” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so that, for example, “about 1” may also mean from 0.5 to 1.4.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

What is claimed is:

1. A fiberoptic connector, comprising:
a plug portion including a first lens array element connected to a plurality of optical fibers;
a socket portion including a second lens array optically coupled to a photonic chiplet;
a first alignment feature including a first sphere fixedly attached to one of the plug portion and the socket portion and further including a first groove in another one of the plug portion and the socket portion,
wherein the first groove is configured to guide the first sphere into a stable position within the first groove to achieve an optically aligned state for the first and second lens arrays in which the plurality of optical fibers is optically coupled to a corresponding plurality of photonic components in the photonic chiplet.

2. The fiberoptic connector of claim 1, wherein the corresponding plurality of photonic components includes one or more components selected from the group consisting of a grating coupler, a turning mirror, a photodetector, and a laser.

3. The fiberoptic connector of claim 1,
wherein the first sphere is fixedly attached in a second groove, the second groove being in the first lens array; and
wherein the first groove is in the second lens array.

4. The fiberoptic connector of claim 1,
wherein the first sphere is fixedly attached in a second groove, the second groove being in the second lens array; and
wherein the first groove is in the first lens array.

5. The fiberoptic connector of claim 1, wherein the first groove has a concave shape having a unique stable position for the first sphere.

6. The fiberoptic connector of claim 5, wherein the first groove is V-shaped.

7. The fiberoptic connector of claim 1,
wherein the first groove is in a layer of crystalline silicon; and
wherein a first facet of the first groove is parallel to a (111) crystallographic plane of the crystalline silicon.

8. The fiberoptic connector of claim 7, wherein a second facet of the first groove is parallel to a (100) crystallographic plane of the crystalline silicon.

9. The fiberoptic connector of claim 1, wherein the first sphere comprises a material selected from the group consisting of glass, fused silica, zirconia, ceramic, alumina, silicon nitride, metal, metal alloy, and polymer.

10. The fiberoptic connector of claim 1,
wherein the first sphere is one of a plurality of spheres fixedly attached to said one of the first and second lens arrays; and
wherein the first groove is one of a plurality of grooves in said another one of the first and second lens arrays, the plurality of grooves hosting the plurality of spheres.

11. The fiberoptic connector of claim 1, further comprising a second alignment feature having a first component in the plug portion and a second component in the socket portion,
wherein the first and second components are configured to bring the first sphere into a capture range of the first groove when the plug portion is inserted into the socket portion.

12. The fiberoptic connector of claim 11,
wherein the first component includes a first pin; and
wherein the second component includes a first pin guide configured to mate with the first pin.

13. The fiberoptic connector of claim 12,
wherein the first component further includes a second pin;
wherein the second component further includes a second pin guide configured to mate with the second pin; and
wherein a plane passing through a center axis of the first pin guide and a center axis of the second pin guide is substantially orthogonal to a beachfront direction of the photonic chiplet.

14. The fiberoptic connector of claim 13,
wherein the plug portion has a substantially rectangular footprint having a long side and a short side;
wherein, in the optically aligned state, the long side of the footprint is substantially parallel to the beachfront direction; and
wherein the plurality of optical fibers is escaped from the fiberoptic connector over the long side of the footprint.

15. The fiberoptic connector of claim 13,
wherein the plug portion has a substantially rectangular footprint having a long side and a short side;
wherein, in the optically aligned state, the short side of the footprint is substantially parallel to the beachfront direction; and
wherein the plurality of optical fibers is escaped from the fiberoptic connector over the short side of the footprint.

16. The fiberoptic connector of claim 1,
wherein the first component includes a sidewall of the first lens array; and
wherein the second component includes a surface configured to guide the sidewall such as to direct the first sphere into the capture range of the first groove.

17. A method for manufacturing a fiberoptic connector, the method comprising:
assembling a plug portion of the fiberoptic connector, wherein the assembling includes connecting a first lens array to a plurality of optical fibers;
making a socket portion of the fiberoptic connector, wherein the making includes attaching a second lens array to a photonic chiplet such that a plurality of lenses of the second lens array is optically coupled to a corresponding plurality of photonic components in the photonic chiplet; and
gluing a first sphere to one of the first and second lens arrays, wherein another one of the first and second lens arrays has a first groove configured to register with the first sphere,
wherein the first groove is configured to guide the first sphere into a stable position within the first groove to achieve an optically aligned state for the first and second lens arrays in which the plurality of optical fibers is optically coupled to the corresponding plurality of photonic components.

18. The method of claim 17, wherein the attaching is performed after optically aligning the second lens array with the corresponding plurality of photonic components in the photonic chiplet using a golden plug portion.

19. The method of claim 17, further comprising forming the first groove in a layer of crystalline silicon using anisotropic etching,
wherein a first facet of the first groove is parallel to a (111) crystallographic plane of the crystalline silicon; and
wherein a second facet of the first groove is parallel to a (100) crystallographic plane of the crystalline silicon.

20. The method of claim 17, wherein the gluing comprises catching an overflow of adhesive in one or more trench grooves located next to a site of the first sphere in said one of the first and second lens arrays.
